(19) United States
(12) Patent Application Publication
(10) Pub. No.: US 2005/0110770 A1
(43) Pub. Date: May 26, 2005

(54) Apparatus for storage and reproduction of image data

(75) Inventors: Michael Johanna Franciscus Van der Geer, Leiden (NL); Hendrik Antonius Vrooman, Rotterdam (NL); Adinda Freudenthal, Rotterdam (NL)

Correspondence Address: PEACOCK MYERS AND ADAMS P C, P O BOX 26927, ALBUQUERQUE, NM, 871256927, US

(73) Assignees: TECHNISCHE UNIVERSITEIT DELFT, Delft (NL); ACADEMISCH ZIEKENHUIS ROTTERDAM, Rotterdam (NL)

(21) Appl. No.: 10/962,238

(22) Filed: Oct. 8, 2004

Related U.S. Application Data
(63) Continuation of application No. PCT/NL03/00263, filed on Apr. 8, 2003.

(30) Foreign Application Priority Data
Apr. 10, 2002 (NL) NL 1020351

(51) Int. Cl. G09G 5/00

(52) U.S. Cl. 345/173

(57) ABSTRACT

An apparatus for storage and reproduction of image data, comprising a computer, a memory control by the computer and an image monitor connected to the computer and suitable for reproduction of image data stored in the memory, or for real-time reproduction of such image data, wherein the same is comprised of a console defining a pre-determined spatial surroundings, within which a field is present that can be disrupted by manually operable means, and wherein the console is provided with a measuring member for determining the disruption of the field, with which measuring member the computer is connected for, subject to the measured field disruption, carrying out a manipulation on the image data.

The invention relates to an apparatus for storage and reproduction of image data, comprising a computer, a memory controlled by the computer and an image monitor connected to the computer and suitable for reproduction of image data stored in the memory; or for real-time reproduction of such image data.

Such an apparatus is known from hospital practise. In the known apparatus the image data is generally three-dimensional and relates to, for example, a part of a patient's body to be examined. Incidentally, the invention is not necessarily limited to this application, but is also useful in other situations that a person skilled in the art can conceive of without further explanation.

When using the apparatus for image data obtained from a patient, the image data will not only be stored and reproduced but will also be analysed and manipulated. The image data may originate from CT-scans, MRI-scans and the like.

When using the known apparatus in the above-sketched situation, it is a problem that the time available to the radiologists for the valuation is under pressure, which is partly due to the fact that the image data obtained are caught up in data sets that become increasingly larger and more complex. In addition, the number of patients whose image data needs to be evaluated, also increases.

It is the object of the invention to provide an apparatus that enables the user of the apparatus to navigate through the image data in a more natural and therefore easier manner, to make selections, make evaluations and record reports on the subject.

To this end the apparatus proposed by the invention is characterised in that the same is comprised of a console defining a pre-determined spatial surroundings, within which a field is present that can be disrupted by manually operable means, and that the console is provided with a measuring member for determining the disruption of the field, with which measuring member the computer is connected for, subject to the measured field disruption, carrying out a manipulation on the image data.

In this simple manner it becomes possible by suitably operating the external means to carry out a desired manipulation of the image data.

The possible advantages that the invention offers may be achieved in particular by the external means for the disruption of the field, being embodied as a substantially flat instrument and by further organising the field, the instrument and the measuring member such as to allow a position assumed by the instrument in the field, to be detectable. This offers among other things the possibility to, based on the position assumed by the instrument in the field, derive a cross-sectional plane of the image data.

It is self-evident that the apparatus according to the invention makes it possible to navigate through the image data in a very natural manner. This is achieved in particular by embodying the apparatus such that the cross-sectional plane of the image data relates to a sub-collection of the image data that, when the instrument is put in the desired position, is visible on the image monitor.

Conveniently, the instrument is provided with at least one control unit for activating the selection of a desired cross-sectional plane and/or storage of a selected image or a cross-sectional plane in the memory. In this way the user of the apparatus has complete control over the choice of consecutive images or cross-sectional planes to be placed in succession, so as to allow insight into the process of evaluation of the image data for verification afterwards. The images may be provided with written or spoken commentary. This may be done per individual image or per (freely selectable) group of images. This is extremely useful for the radiologist when making a report and is also useful for providing the process of diagnosing with commentary. The final diagnostic report can then be simply derived from the images. The images also function as access points to the rough collection of image data. The activation of an image (“double click”) allows a quick movement to the corresponding position in the image data collection.

From an ergonomic point of view it is advantageous that the at least one control unit of the instrument is placed at one side of it so as to allow the instrument to be operated with one hand.

The ergonomics when using the apparatus may be further improved by providing the apparatus with an electronic pen suitable for the manipulation of the image data.

It has been shown to be useful for the pen to have a control button for activating the storage of a selected image or a cross-sectional plane in the memory. This provision allows the instrument to be operated with, for example, the left hand determining the position of the cross-sectional plane, while the pen is held in the other hand for activating the desired position of the cross-sectional plane or for storing the image selected therewith.

Further, for an adequate documentation of the diagnostic process it is desirable for the pen to have an erase and/or writing function. In this way the pen can be used for carrying out a desired manipulation in the selected image data or for adding a written commentary.

Hereinbelow the invention will be further elucidated with reference to a preferred embodiment of the apparatus according to the invention.

It is expressly observed that the preferred embodiment discussed below merely concerns an example and that the appended claims are not limited to this preferred embodiment. The elucidation referring to the example below merely serves to clarify possible ambiguities in the claims.

The explanation given hereafter refers to the drawing, which

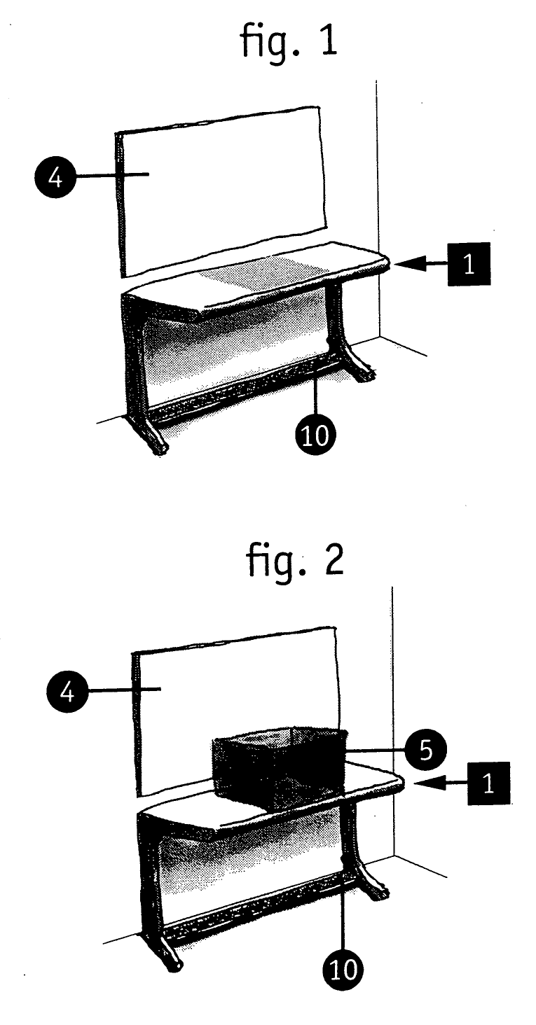

in FIG. 1 shows the console according to the invention;

in FIG. 2 shows the console according to FIG. 1 with the spatial surroundings defined thereby in which there is a disruptable field;

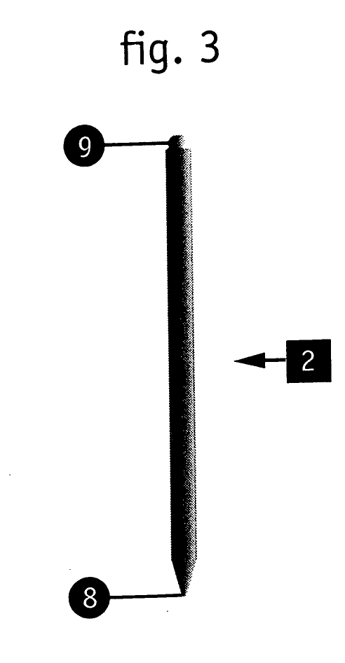

in FIG. 3 shows the pen of the apparatus according to the invention; and

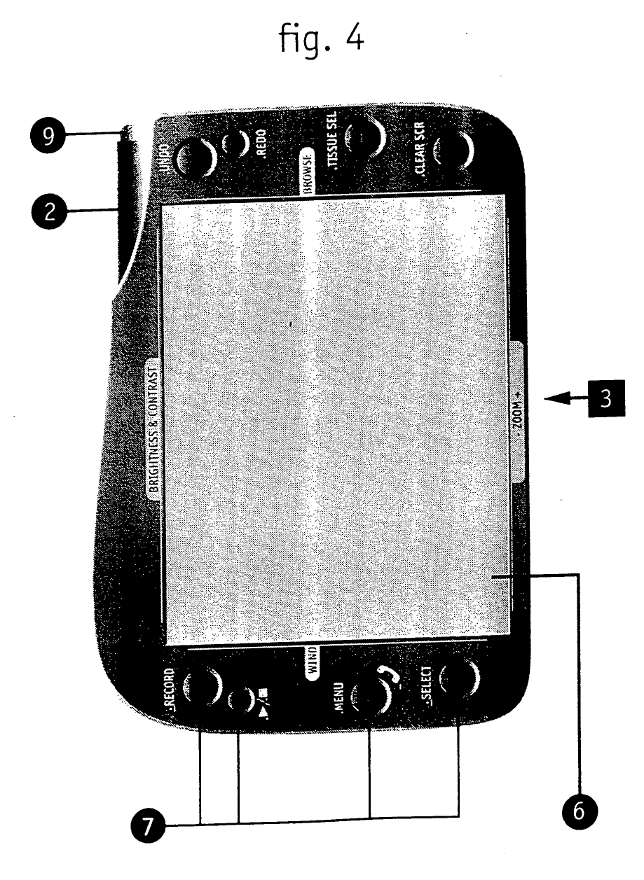

in FIG. 4 shows the instrument for the disruption of the field.

Similar parts in the figures carry identical reference numbers.

The console 1 shown in FIG. 1 is part of the apparatus according to the invention. The FIGS. 3 and 4 show other parts of the apparatus, namely the portable pen 2 (see FIG. 3) and the instrument 3 (see FIG. 4). The function of both of these portable parts will hereafter be explained further.

The pen 2 shown in FIG. 3 and the instrument 3 shown in FIG. 4 are wireless and serve for operating the apparatus according to the invention. The radiologist using the apparatus for storage, manipulation and reproduction of the radiological image data can have these items with him as his personal set of instruments. Thus each radiologist may have a set of instruments at his disposal in which his personal adjustments are stored, which he uses for operating the apparatus of which the stationary part, namely the console 1, is shown in FIG. 1.

In the console 1, or connected thereto, may be a computer and also a memory controlled by the computer. The console 1 is further provided with a monitor 4 connected to the computer (not shown) and suitable for the reproduction of radiological image data stored in the memory. It is also possible for the monitor 4 to show real-time reproduction of image data obtained from a patient at that moment. In general the image data are of a radiological nature and may relate to CT-scans or MRI-scans or the like.

The apparatus according to the invention differs from prior art apparatus for storage and reproduction or manipulation of radiological image data, respectively, in the sense that there is no keyboard or mouse present for operating the earlier mentioned computer. The control of the apparatus is completely concentrated in the portable parts, that is to say the pen 2 in accordance with FIG. 3 and the instrument shown in FIG. 4.

The monitor 4 shows what the radiologist is evaluating. This may be two-dimensional and three-dimensional images, as well as alphanumerical patient data. One thing and another may optionally be further supplemented by additional information, in accordance with the requirements of the respective user of the apparatus.

FIG. 2 schematically shows that the console 1 has a pre-determined spatial surroundings 5, within which a field is present that can be disrupted by means of the instrument 3 shown in FIG. 4. This field may be an optically generated field or may be generally of electromagnetic nature. In the following the further elucidation will be based on a magnetic field provided in the spatial surroundings 5, that is disruptable by means of the instrument 3.

According to the invention the console 1 is further provided with a measuring member for determining the disruption of the field provided in the spatial surroundings 5. The manner in which the magnetic field is generated, as well as the manner in which possible disruptions in this field are detected are known to the person skilled in the art, so that they do not need to be explained further.

To the measuring member mentioned above, a computer of the apparatus, also known to the person skilled in the art and therefore not shown, is connected so that, subject to the measured field disruption, the image data shown on the monitor 4 can be manipulated.

As will be clear from the above, the instrument 3 shown in FIG. 4 is suitable for disrupting the magnetic field in the spatial surroundings 5. This instrument 3 is substantially flat, so that this instrument 3, as it were, defines a plane that corresponds with a desired cross-sectional plane whose position is determined by the position assumed by the instrument 3 in the magnetic field in the predetermined spatial surroundings 5.

The instrument 3 of the embodiment shown is itself also provided with a display 6.

As can be clearly seen in FIG. 4, the instrument 3 is at least on one side provided with control members 7 with which a number of the most important functions that can be controlled by means of the instrument 3, can be activated. By operating these control members 7 it is possible, for example, to store a desired cross-sectional plane and/or a selected image of a cross-sectional plane in the memory. Because these most important control members are placed on one side of the instrument 3, this instrument is suitable to be held in the non-favoured hand so that by operating these control members 7, this non-favoured hand can be used also for certain operations. Incidentally, control members may be provided at the side opposite to the side of the control members 7.

With further reference to FIG. 3, the pen 2 is shown, which is equipped to carry out an erase and/or writing function on the image data. For the writing function, a first end 8 of the pen 2 may be moved along the monitor 4 (see FIGS. 1 and 2) or along the display 6 of the instrument 2 (see FIG. 4). The pen may also be used as pointer. This will require no further explanation for the person skilled in the art.

The other end of the pen 2 is provided with a control button 9 for activating the storage of an image or particular cross-sectional plane selected with the instrument 3 in the memory of the computer, or in a memory connected with the computer. For the eraser function, the operating button 8 of the pen 2 has to be moved along the monitor 4 or along the display 6 of the instrument 3.

Finally, attention may be drawn to the fact that the console 1 is provided with a pedal 10 for, subject to the position of the pedal 10, showing the image data on the monitor 4 and/or the display 6 of the instrument 3.

When an object on the screen moves, the pedal 10 indicates when movements of the instrument 3 have to be translated into movements of that object: depression of the pedal=object moves with the instrument 3 (object copies the movements), no depression=ignore movements of the instrument 3.

With so-called flythroughs, the user initially holds the instrument 3 still and the image data collection subset displayed moves, as it were, through the instrument 3. The position of the pedal 10 determines the direction of the movement: backward impression of the pedal=backward, forward impression=forward. By rotating the instrument 3, the user is able to, as it were, use the instrument 3 to “look around” in the organ being “flown through”. These movements are not translated as movements of the image data. This “looking around” may be done both during the progress through the image data by using the pedal 10 and during stand-still of the image data.

1. An apparatus for storage and reproduction of image data, comprising a computer, a memory controlled by the computer and an image monitor connected to the computer and suitable for reproduction of image data stored in the memory, or for real-time reproduction of such image date, wherein the same is comprised of a console defining a pre-determined spatial surrounds, within which a field is present that can be disrupted by manually operable means, and wherein the console is provided with a measuring member for determining the disruption of the field, with which measuring member the computer is connected for, subject to the measured field disruption, carrying out a manipulation on the image data.

2. An apparatus according to claim 1, wherein the manually operable means for the disruption of the field is embodied as a substantially flat instrument, and wherein the field, the instrument and the measuring member are designed for detecting a position assumed by the instrument in the field.

3. An apparatus according to claim 2, wherein based on the position assumed by the instrument in the field, a cross-sectional plane of the image data can be derived.

4. An apparatus according to claim 3, wherein the cross-sectional plane of the image data relates to a sub-collection of the image data that, when the instrument is put in the desired position, is visible on the image monitor.

5. An apparatus according to claim 2, wherein the instrument is provided with at least one control unit for activating the selection of a desired cross-sectional plane and/or storage of a selected image or a cross-sectional plane in the memory.

6. An apparatus according to claim 2, wherein the at least one control unit of the instrument is placed at one side of it so as to allow the instrument to be operated with one hand.

7. An apparatus according to claim 1, wherein an electronic pen is provided suitable for the manipulation of the image data.

8. An apparatus according to claim 7, wherein the pen has a control button for activating the storage of a selected image or a cross-sectional plane in the memory.

9. An apparatus according to claim 7, wherein the pen has an erase and/or writing function.

10. An apparatus according to claim 2, wherein the console is provided with a pedal for, subject to the position of the pedal, showing the image data on the monitor and/or the display of the instrument.

11. An instrument clearly intended for use as a part of the apparatus in accordance with claim 2.

12. A pen clearly intended for use as part of the apparatus in accordance with claim 7.
